(19) United States
(12) Patent Application Publication
(10) Pub. No.: US 2026/0023384 A1
(43) Pub. Date: Jan. 22, 2026

(54) FLIGHT MANAGEMENT BASED ON MAXIMUM ALTITUDE USING A NEURAL NETWORK

(71) Applicant: Rockwell Collins, Inc., Cedar Rapids, IA (US)

(72) Inventors: Shih-Yih YOUNG, Marion, IA (US); Sebin K KOTTACKAL, Bangalore (IN); Mark W. VOLNER, Huxley, IA (US); Dinesh Kumar KUSHWAHA, Bangalore (IN)

(73) Assignee: Rockwell Collins, Inc., Cedar Rapids, IA (US)

(21) Appl. No.: 18/775,473

(22) Filed: Jul. 17, 2024

(51) Int. Cl. G05D 1/48; G06N 3/08

(52) U.S. Cl. CPC G05D 1/48; G06N 3/08

(57) ABSTRACT

A neural network model predicts a maximum altitude for an aircraft based on factors. The neural network model is trained using aircraft performance tables that include specified parameters and variable parameters. The specified parameters include a residual rate of climb (RROC) threshold and a maneuver margin threshold. The variable parameters include an aircraft gross weight, a temperature, a cruise airspeed, and a present altitude. The variable parameters change within the table while the specified parameters do not. The altitude is incremented and the gross aircraft weight is determined based on a climb profile using the energy method to determine fuel consumption. After these changes, it is determined whether the parameters fail criteria for the maximum altitude. If one of the criteria is not met, then the maximum altitude for the table is determined based on the parameters. The tables and maximum altitudes are used to train the neural network model.

### FIELD OF THE INVENTION

The subject matter disclosed herein relates to flight management using a neural network to compute maximum altitudes and, in particular, to flight management using the neural network trained with aircraft performance datasets.

### BACKGROUND OF THE INVENTION

Maximum altitude represents the highest altitude that an aircraft can safely maintain, given the performance capability of the aircraft, environmental conditions, and the limitations with the planned speed schedules for both climb and cruise. Thus, maximum altitude is a critical parameter to ensure flight safety.

The determination of a maximum altitude is through a highly nonlinear function that is affected by multiple factors, such as airspeed, gross weight, and the like. The computation of the maximum altitude currently is performed by both the look-up of aircraft performance tables and the linear interpolation method, both of which are computationally intensive. In addition, the aircraft performance tables provided by the original equipment manufacturers (OEMs) usually are limited to one set of parameter configurations that can be used to determine maximum altitudes for a few specific aircraft maneuvers. Airlines, however, have been demanding the maximum altitude to be computed for various allowable aircraft maneuvers that are required by aviation authorities in different regions around the world.

It may be appreciated that a need exists for an improved method to determine maximum altitudes in terms of computational efficiency as well as being able to compute maximum altitudes for all aircraft maneuvers that are requested by customers.

### SUMMARY OF THE INVENTION

The present disclosure is directed, in a first aspect, to a method for training a neural network model for determining a maximum altitude for an aircraft. The method includes generating a table having a value for a parameter of a residual rate of climb (RROC) threshold and a value for a parameter for a maneuver margin threshold. The method also includes populating the table with values for a plurality of variable parameters. The plurality of variable parameters includes an aircraft gross weight, a temperature, a cruise airspeed, and a present altitude. The method also includes updating the value for the present altitude according to a vertical integration step. The method also includes propagating a climb profile using an energy method for the vertical integration step to determine an amount of fuel used in climbing to the updated present altitude. The method also includes adjusting the aircraft gross weight in the table based on the amount of fuel used. The method also includes determining whether the values of parameters in the table fail to meet a plurality of criteria for the updated present altitude. The method also includes, if the values of the parameters fail to meet the criteria, determining a maximum altitude associated with the values for the parameters. The method also includes training the neural network model with the parameters in the table and the maximum altitude. The neural network module is trained to determine a predicted maximum altitude for the aircraft.

In yet another embodiment, the present disclosure is directed to a method for training a neural network model for determining a maximum altitude for an aircraft. The method includes generating aircraft performance tables. Each table includes a plurality of specified parameters and a plurality of variable parameters. The plurality of specified parameters includes a residual rate of climb (RROC) threshold and a maneuver margin threshold. The plurality of variable parameters includes an aircraft gross weight, a temperature, a cruise airspeed, and a present altitude. The plurality of variable parameters changes within the aircraft performance tables. The method includes determining a maximum altitude for each table of the aircraft performance tables by incrementing the present altitude according to the vertical integration step, adjusting the aircraft gross weight using an energy method for a climb rate, and determining the maximum altitude for the table if the plurality of specified parameters and the plurality of variable parameters fail to meet one of a plurality of criteria. The method also includes training the neural network model using the maximum altitudes for the aircraft performance tables having the plurality of specified parameters and the plurality of variable parameters. The neural network model is configured to predict the maximum altitude for the aircraft.

In yet another embodiment, the present disclosure is directed to a system having a neural network model to predict a maximum altitude for an aircraft. The system includes the neural network model. The neural network model includes at least one hidden layer having a plurality of neurons configured to receive a plurality of factors associated with an aircraft. The neural network model also includes an output layer having a plurality of neurons to receive an output of the plurality of neurons of the at least one hidden layer and predict the maximum altitude for the aircraft. The at least one hidden layer and the output layer are trained by aircraft performance tables. The system also includes a processor and a memory. The memory includes instructions that, when executed on the processor, configures the processor to generate the aircraft performance tables. Each table includes a plurality of specified parameters and a plurality of variable parameters. The plurality of specified parameters includes a residual rate of climb (RROC) and a maneuver margin threshold. The plurality of variable parameters includes an aircraft gross weight, a temperature, a cruise airspeed, and a present altitude. The plurality of variable parameters changes within the aircraft performance tables. The processor also is configured to determine a maximum altitude for each table of the aircraft performance tables by incrementing the present altitude according to a vertical integration step, adjusting the aircraft gross weight using an energy method for a climb rate, and determining the maximum altitude for the table if the plurality of specified parameters and the plurality of variable parameters fail to meet one of a plurality of criteria. The processor also is configured to train the neural network model using the maximum altitudes for the aircraft performance tables having the plurality of specified parameters and the plurality of variable parameters. The neural network model is configured to predict the maximum altitude for the aircraft.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF FIGURES

The features of the disclosure believed to be novel and the elements of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 illustrates a block diagram of a system having a maximum altitude neural network model according to the disclosed embodiments.

FIG. 2 illustrates aircraft performance training data tables having parameters according to the disclosed embodiments.

FIG. 3 illustrates a flowchart for determining a maximum altitude for a combination of parameters in a table according to the disclosed embodiments.

FIG. 4 illustrates a block diagram of an example neural network topology for the maximum altitude neural network model according to the disclosed embodiments.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

In other instances, well-known features may not be described in detail to avoid unnecessarily complicating the instant disclosure. The concepts disclosed herein are capable of other embodiments or of being practiced or performed in various ways. Further, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features that may not necessarily be expressly described or inherently present in the instant disclosure.

The inventive concepts may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

To address the technical need set forth above, the disclosed embodiments implement an energy method-based design to accurately create aircraft performance tables for various aircraft maneuvers. With these additional performance tables that are not provided by OEMs, the disclosed embodiments may compute the maximum altitude for all aircraft maneuvers that are required by airlines and aviation authorities around the world.

The disclosed embodiments also implement a neural network-based design to train a deterministic and certifiable neural network to compute maximum altitudes by using the aircraft performance tables as training datasets. After the neural network is fully trained, it may be used to predict the maximum altitude in an efficient and accurate manner.

Maximum altitude represents the highest altitude that an aircraft can maintain, given the aircraft's performance capabilities, environmental conditions, and the planned speed schedule. Maximum altitude may be the smallest value of thrust-limited altitude by complying with the residual rate of climb criterion, maneuver-margin-limited altitude or buffet limited maximum altitude, and maximum certified structural altitude of the aircraft. Thrust limited altitude usually is the determining factor for the maximum altitude. Further, at the maximum altitude, the feasible airspeed range is limited. In other words, the gap between the lowest and highest speeds is small, which can result in a safety risk to the aircraft.

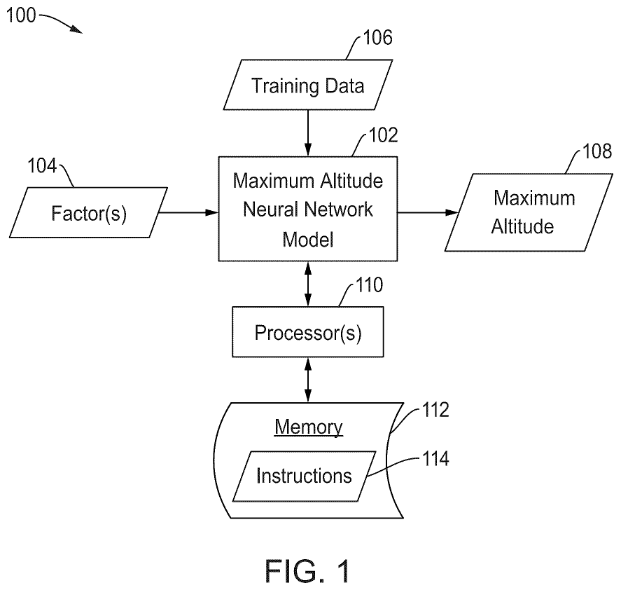

FIG. 1 depicts a block diagram of a system 100 having a maximum altitude neural network model 102 according to the disclosed embodiments. System 100 may be implemented in a device, computer, application, and the like to determine a maximum altitude 108 based on one or more factors 104. Factors 104 may include airspeed, gross weight, current altitude, temperature, and the like.

System 100 may implement training data 106 to train maximum altitude neural network model 102. Thus, there may be at least two processing stages for computing maximum altitude. The first stage may be using the energy method to generate the tabulated data of maximum altitudes that are used as the training data 106. The second stage may be training maximum altitude neural network model 102 based on the training data 106. Once trained, maximum altitude neural network model 102 is used to predict maximum altitude 108.

System 100 includes one or more processors 110 that execute instructions 114 stored in memory 112 to enable the functionality disclosed herein with regards to maximum altitude neural network model 102. One or more processors 110 execute the operations to generate training data 106 and use the training data to train maximum altitude neural network model 102. They also execute the operations to predict maximum altitude 108. One or more processors 110 may be hosted in a computing environment such that the processors and memories are communicatively connected to each other.

The disclosed embodiments may use the energy method, disclosed in greater detail below, to propagate the climb trajectory for the determination of maximum altitude 108. The disclosed embodiment, at least initially, presume the aircraft is already in a cruise mode. This feature alleviates the need to determine the climb ceiling during a climb phase. Further, the disclosed embodiments may presume all engines on the aircraft are operable and only one thrust setting and one engine bleed setter are used.

The maximum altitude may be a nonlinear function of a plurality of parameters that are evaluated at the altitude being assessed. To accurately determine maximum altitude 108, the energy method is iteratively integrated from the present altitude for a climb profile that reaches the highest altitude that still complies with all criteria. Thus, the changes of true airspeed, temperature, aircraft weight, and the like as factors 104 may be properly accounted for within integration segments that are from the present position of the aircraft to the maximum altitude.

In some instances, the maximum altitude is a nonlinear function of at least the following six parameters:
1. Residual rate of climb (RROC) threshold
2. Maneuver margin threshold
3. Aircraft gross weight
4. Temperature
5. The cruise airspeed schedule (Mach number)
6. The present altitude

For each combination of RROC threshold and maneuver margin threshold, the maximum altitude may be captured in a four-dimensional table that corresponds to the remaining four input parameters, such as gross weight, temperature, speed schedule, and present altitude. The maximum altitude table for each of these four combinations may be used as training data 106 to train maximum altitude neural network model 102.

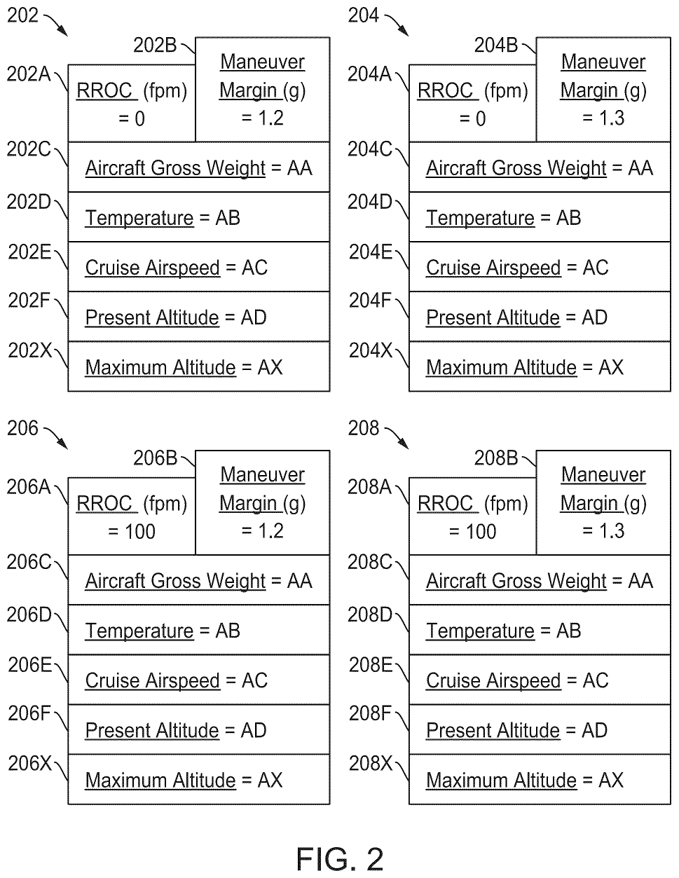

FIG. 2 depicts aircraft performance training data tables 202, 204, 206, and 208 according to the disclosed embodiments. A training data table may be generated for each RROC threshold and maneuver margin threshold combination for the aircraft. Each table includes a plurality of specified parameters and a plurality of variable parameters. The specified parameters may be RROC threshold and the maneuver margin threshold.

For example, the values for the RROC threshold may be in the range of 0 to 100 feet per minute (fpm). The maneuver margin threshold may be in the range of 1.2 and 1.4 g forces (g). The tables disclosed in FIG. 2 are examples, and any number of tables with multiple RROC threshold and maneuver margin threshold combinations may be generated. These tables are further populated with values for the plurality of variable parameters, disclosed in greater detail below.

The plurality of variable parameters includes the aircraft gross weight, the temperature, the cruise airspeed, or planned speed schedule, and the present altitude. These parameters are variable as they may change during each iteration of the climb profile. For example, the aircraft may be determined to climb a certain amount, which may be referred to as a vertical integration step, such as 50 ft. Updated values for the variable parameters may be determined after each vertical integration step and compared to criteria related to the specified parameters.

Referring to table 202, parameter 202A is the RROC threshold. Here, parameter 202A has a value of 0 fpm. Parameter 202B is the maneuver margin threshold having a value of 1.2 g. Parameter 202C is the aircraft gross weight, which may have a value of AA. The values for AA may include a range of values based on the range of input weight. For example, the values for AA may range from 80,000 to 156,450 lbs. Values also may be in metric units, depending on the aircraft manufacturer. These weights may be input from a file provided to system 100.

Parameter 202D is the temperature value outside the aircraft. Parameter 202D may have a value of AB. The values of AB may include a range of values based on the temperatures commonly observed during flying operations. For example, the values for AB may be, in Celsius, −10, 0, 5, 10, 15, 20, and 35 degrees. These temperature values may be provided by a file inputted to system 100.

Parameter 202E is the cruise airspeed having a Mach number. This parameter also may be known as the planned speed schedule, for the current speed of the aircraft. Parameter 202E may have a value of AC. The values for AC may include a range of values based possible aircraft cruise speeds based on aircraft capability. For example, the values for AC may be 0.60, 0.65, 0.70, 0.72, 0.74, 0.77, 0.80, and 0.82 Mach. These speed values may be provided by a file input to system 100.

Parameter 202F is the present altitude of the aircraft. Parameter 202E may have a value of AD. The values of AD may include a range of values based on the potential starting altitudes for the aircraft. For example, the values for AD may be between 13,000 and 42,000 ft, in increments of 3000 ft. The maximum value may correspond to the maximum structure altitude for the aircraft. These present altitude values may be provided by a file input to system 100.

Using the disclosed processes, a maximum altitude 202X having a value of AX will be determined for the parameters loaded into table 202. The values of the parameters disclosed above may be placed into table 202 for parameter 202A of the RROC threshold and parameter 202B for the maneuver margin threshold. The disclosed embodiments may determine a plurality of maximum altitudes AX for parameters 202A and 202B for each combination of values for parameters 202C, 202D, 202E, and 202F.

For example, value AA for parameter 202C may be 80,000 ft, value AB for parameter 202D may be 0 degrees Celsius, value AC for parameter 202E may be 0.60 Mach, and value AD for parameter 202F may be 13,000 ft. Maximum altitude AX is determined from this combination of parameters and stored as table 202 for that combination. The values for parameters 202C, 202D, and 202E may stay the same but value AD for parameter 202F may be changed to 16,000 ft and the disclosed process executed to determine another maximum altitude AX for this combination of parameters. Table 202 is stored for this combination. This process is repeated until all possible values for the parameters are used to capture the maximum altitudes for the combinations.

The disclosed process is repeated for tables 204, 206, and 208. Parameter 204A for table 204 is the RROC threshold and has a value of 0 ft. Parameter 204B is the maneuver margin threshold and has a value of 1.3 g. Parameter 204C is the aircraft gross weight and has a value of AA, subject to the ranges disclosed above for table 202. Parameter 204D is the temperature and has a value of AB, subject to the ranges disclosed above for table 202. Parameter 204E is the cruise airspeed, or Mach number, and has a value of AC, subject to the ranges disclosed above for table 202. Parameter 204F is the present altitude and has a value of AD, subject to the ranges disclosed above for table 202. The disclosed process is executed to determine maximum altitude BX for each combination of values for the parameters.

While the values for parameters 202C-202F and 204C-204F may remain the same within tables 202 and 204, the maximum altitude values will be different based on the different values for the RROC threshold or the maneuver margin threshold. Thus, the value AX for maximum altitude 202X should differ from the value BX for maximum altitude 204X.

Table 206 includes a value of 100 fpm for parameter 206A of the RROC threshold and a value of 1.2 g for parameter 206B of the margin maneuver threshold. Table 206 also includes parameters 206C, 206D, 206E, and 206F having values AA, AB, AC, and AD (disclosed above), respectively. Using the disclosed processes, maximum altitude 206X having a value of CX is determined for each combination of parameters in table 206. Table 208 includes a value of 100 fpm for parameter 208A of the RROC threshold and a value of 1.3 g for parameter 208B for the margin maneuver threshold. Table 208 also includes parameters 208C, 208D, 208E, and 208F also having values AA, AB, AC, and AD (disclosed above), respectively. Using the disclosed processes, maximum altitude 208X having a value of DX is determined for each combination of parameters in table 208.

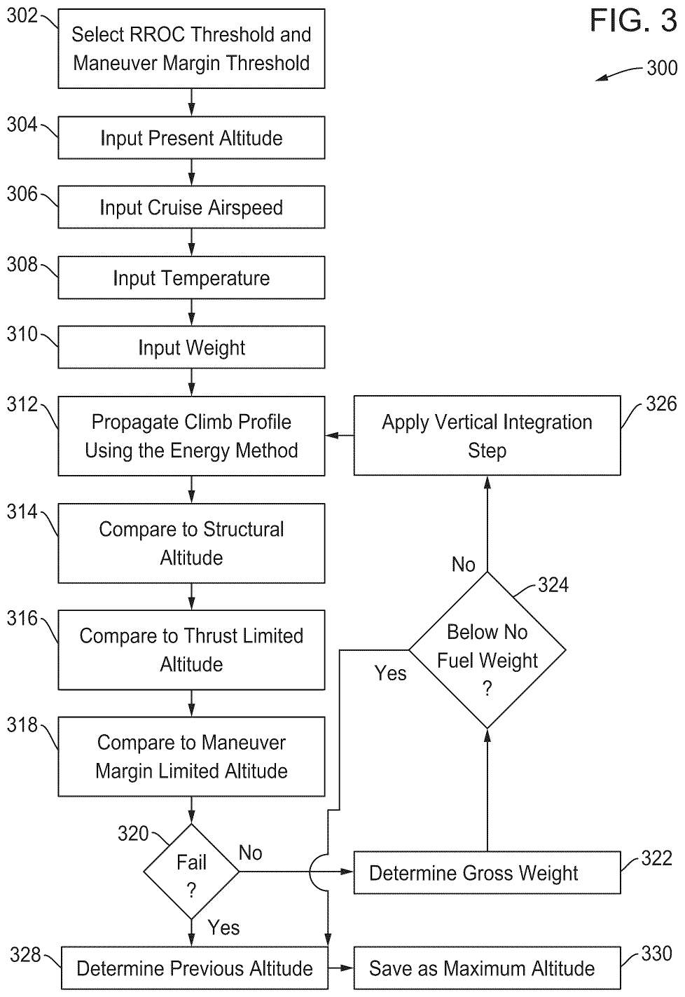

FIG. 3 depicts a flowchart 300 for determining a maximum altitude for a combination of parameters in a table according to the disclosed embodiments. Flowchart 300 may refer to FIGS. 1 and 2 for illustrative purposes. Flowchart 300, however, is not limited to the embodiments disclosed by FIGS. 1 and 2.

Step 302 executes by selecting a combination of values for the RROC threshold and the maneuver margin threshold. A table will be generated for the combination, such as parameter 202A for a RROC threshold of 0 fpm and parameter 202B for a margin maneuver threshold of 1.2 g as disclosed in table 202. Step 304 executes by inputting a value for the present altitude parameter, such as a value of the range of values AD for parameter 202F into the table. Step 306 executes by inputting a value for the cruise airspeed parameter, such as a value of the range of values AC for parameter 202E into the table.

Step 308 executes by inputting a value for the temperature parameter, such as a value of the range of values AB for parameter 202D into the table. Step 310 executes by inputting a value for the aircraft gross weight parameter, such as value of the range of values AA for parameter 202C into the table. Thus, a table is generated for the parameters for the combination of values for RROC threshold and the maneuver margin threshold.

Step 312 executes by propagating a climb profile from the present altitude. The climb profile is propagated using the energy method with the aircraft weight gradually reduced due to fuel burn. Given true airspeed V_{T}, the flight path angle relative to the airmass γₐ during climb can be determined as follows.

$$\frac{dh}{dt} = {V}_{T} sin {γ}_{a} , \qquad Equation 1$$

with γₐ as the flight path angle relative to the air mass.

Using two values at consecutive waypoints for integration, γ₁ at waypoint 1 and γ₂ at waypoint 2 may be determined as follows.

$$sin {γ}_{a , 1} = \frac{( {T}_{1} - {D}_{1} )}{{W}_{1} ( \frac{1}{2} ( \frac{{Te}_{1}}{{Te}_{1 \_ std}} + \frac{{Te}_{2}}{{Te}_{2 \_ std}} ) + {AF}_{1} + {WAG}_{1} )} \qquad Equation 2$$

$$sin {γ}_{a , 2} = \frac{( {T}_{2} - {D}_{2} )}{{W}_{2} ( \frac{1}{2} ( \frac{{Te}_{1}}{{Te}_{1 \_ std}} + \frac{{Te}_{2}}{{Te}_{2 \_ std}} ) + {AF}_{2} + {WAG}_{2} )} \qquad Equation 3$$

Where,
γ_{a, 1} is the γₐ at waypoint 1 and γ_{a, 2} is the γₐ at waypoint 2;
Te₁ and Te_{1_std} are the current ambient temperature and the standard temperature at waypoint 1, respectively;
Te₂ and Te_{2_std} are the current ambient temperature and the standard temperature at waypoint 2, respectively;
T₁ and T₂ are thrust at waypoints 1 and 2, respectively, from the climb thrust table, which may be provided as aircraft performance tables from the original equipment manufacturer (OEM);
D₁ and D₂ are drag at waypoints 1 and 2, respectively; and
W₁ and W₂ are aircraft gross weight at waypoints 1 and 2, respectively.

With AF₁ and AF₂ defined as

$${AF}_{1} ≡ \frac{{V}_{T 1}}{g} \frac{( {V}_{T 1} - {V}_{T 2} )}{dh} \qquad Equation 4$$

$${AF}_{2} ≡ \frac{{V}_{T 2}}{g} \frac{( {V}_{T 1} - {V}_{T 2} )}{dh} , \qquad Equation 5$$

With WAG₁ and WAG₂ defined as

$${WAG}_{1} = ( \frac{{V}_{T 1}}{g} ) ( \frac{{V}_{w 1} - {V}_{w 2}}{dh} ) \qquad Equation 6$$

$${WAG}_{2} = ( \frac{{V}_{T 2}}{g} ) ( \frac{{V}_{w 1} - {V}_{w 2}}{dh} ) , \qquad Equation 7$$

Where V_{w1} is the wind speed at waypoint 1 and V_{w2} is the wind speed at waypoint 2; and
V_{T1} and V_{T2} are true airspeed at waypoints 1 and 2, respectively.

The horizontal distance relative to air mass for one integration interval is computed as

$${dX}_{air} - \frac{dh}{tan {γ}_{avg}} with {γ}_{avg} = \frac{{γ}_{a , 1} + {γ}_{a , 2}}{2} . \qquad Equation 8$$

The traversal time in units of seconds for one integration interval, such as an altitude step of 50 ft, may be computed as

$${dt}_{air} = \frac{{dX}_{air}}{{V}_{T}} . \qquad Equation 9$$

The delta fuel consumption for one integration interval may be computed as

$${df}_{air} = {F}_{avg} ( \frac{{dt}_{air}}{3600} ) ( \#engines ) ff\_corr , \qquad Equation 10$$

Where F_{avg} is the average fuel consumption in units of pounds per hour and per engine in the integration interval, and ff_corr is the fuel correction factor. This parameter may be commonly used in flight management and associated systems. The parameter also may be provided by the OEM to account for the efficiency of the engines. The value for dfₐᵢᵣ is subtracted for the current aircraft weight. Then, the climb path is propagated again for the next vertical integration step with the newly updated aircraft weight.

In some embodiments, this step is executed using the present altitude parameter and incrementing it by the vertical integration value, such as 50 ft.

Step 314 executes by comparing the adjusted altitude according to the parameters to the structural altitude for the aircraft. This value may be set by the manufacturer of the aircraft and is similar to the maximum altitude allowed for value AD. In other words, the disclosed embodiments check to see if the new altitude exceeds the maximum structural altitude that is acceptable for the aircraft. The structural altitude may be a constant in the disclosed processes.

Step 316 executes by comparing the RROC threshold value to the thrust limited altitude value given the parameters in the table. For example, using table 202, the thrust limited altitude value would be compared to parameter 202A, or 0. The thrust limited altitude, or ThrustLimitMaxAlt, may be the highest altitude that can still comply with the following criterion:

$$Instantaneous {ROC}_{f t / m i n} = ( {Vtas}_{kt} * {101.26859}_{\frac{f t / m i n}{kt}} ) * \frac{( \frac{( {Thrust}_{l bs} - {Drag}_{l bs} )}{{Weight}_{l bs}} )}{[ \begin{matrix}( \frac{( {T}_{{STD}_{° K}} + Δ {ISA}_{° C} )}{{T}_{{STD}_{° K}}} ) + \\ ( ( {2.8487}_{{( \frac{f t / s}{kt} )}^{2}} ) * ( \frac{{Vtas}_{kt}}{{g}_{f t / {s}^{2}}} ) * ( \frac{{dVtas}_{kt}}{{dh}_{f t}} ) )\end{matrix} ]} , \qquad Equation 12$$

The equation for determining the instantaneous rate of climb (ROC) may be

$$ThrustLimitMaxAlt = Highest Altitude where instantaneous rate of climb ( ROC ) \geq RROC threshold . \qquad Equation 11$$

Where Thrust=is computed via a table lookup as a function of f (ThrustRating, Bleedsetting, ΔISA, Mach, PressureAltitude), based on the climb thrust table, as provided by the OEM; and

Drag=is computed as a sum of several table lookups that are a function of f (Thrust, CG, ΔISA, Mach, PressureAltitude). Thus, the instantaneous ROC is determined for the altitude after the adjustment due to the fuel being burned. This value is used to determine the thrust limited altitude value. As long as this value is greater than the RROC threshold, then the present altitude is acceptable for the aircraft. In some embodiments, the thrust limited altitude is most likely to be the criterion that fails.

Step 318 executes by comparing the maneuver margin limited altitude value to the margin maneuver value of the table. For example, using table 202, the maneuver margin limited altitude value would be compared to parameter 202B, or 1.2 g. The maneuver margin limited altitude, or ManeuverMarginMaxAlt, may be the highest altitude that can still comply with the following criterion:

$$ManeuverMarginMaxAlt = Highest Altitude where {C}_{L} * Maneuver\_Margin \geq Buffet {C}_{L} . \qquad Equation 13$$

The value for C_{L} may be determined by

$${C}_{L} = \frac{load factor * GWT}{qS} , \qquad Equation 14$$

Where Maneuver_Margin is a multiplier for the load factor and its value is in the range of 1.2 or 1.3 without a unit. It may be related to the maneuver margin threshold value for the table,

$The load factor = \frac{lift}{GWT} = 1. for straight and level flight ,$
GWT = Gross weight of aircraft in pound,
q = dynamic pressure = f (Mach, PressureAltitude),
S = Wing Reference Area = provided by table lookup of wing reference area,
and
Buffet C_{L} = a table lookup f (ThrustRating, BleedSetting, ΔISA, Mach,
PressureAltitude), which may be a table look up function for the coefficient of lift (C_{L})
provided by the OEM.

Step 320 executes by determining whether the current criteria for the structural altitude, the thrust limited altitude, and the maneuver margin limited altitude are not met as disclosed above for the current altitude. In other words, do the parameters for the current altitude after accounting for the propagation climb profile cause a failure of the conditions set by the criteria. If so, then further propagations of the climb profile are stopped and the parameters for the table are stored with the altitude in force right before steps 312-318 as the maximum altitude. For example, for the values for parameters 202A-202F of table 202 that meet the criteria set forth by the values for the structural altitude, the thrust limited altitude, and the maneuver margin limited altitude prior to the ones that fail, maximum altitude 202X for those values is saved with them for use in training data 106.

If step 320 is no, then further propagation of the vertical climb may occur without failing the criteria disclosed above. Step 322, however, executes to determine the gross weight at the current altitude. This value may be similar to parameter 202C for aircraft gross weight for table 202 taking into account any burned fuel. Step 324 executes by determining whether the aircraft gross weight is below the no fuel weight of the aircraft. In other words, the aircraft gross weight cannot be below the weight of the aircraft with no fuel.

If step 324 is no, then step 326 executes by applying a vertical integration step to the present altitude. In some embodiments, the vertical integration step may be 50 ft. For example, for the combination of parameters in table 202, parameter 202F may be incremented by 50. Flowchart 300 returns to step 312 to further propagate the climb profile using the new altitude and executes step 314-320 to determine if the new values for the criteria fail at the new altitude.

If step 320 or step 324 is no, then step 328 executes by determining the previous altitude prior to the one used in steps 312-320. In other words, if one of the criteria fails at 20,000 ft, then the disclosed embodiments will determine the previous altitude used in the disclosed processes that passed all the criteria. Step 330 executes by saving the previous altitude as the maximum altitude for the applicable table along with the values for the parameters in the table. For example, maximum altitude 202X may be determined for table 202, maximum altitude 204X may be determined for table 202, maximum altitude 206X may be determined for table 206, and maximum altitude 208X may be determined for table 208. The parameters of the tables are stored with the associated maximum altitudes and used for training data 106.

Referring back to FIG. 1, training data 106 is used to train maximum altitude neural network model 102. For example, training data 106 may include a plurality of tables having different maximum altitudes for RROC thresholds and maneuver margin thresholds. The maximum altitudes may differ for the combinations of the RROC thresholds and the maneuver margin thresholds depending on temperature parameters, cruise airspeed parameters, present altitude parameters, and starting aircraft gross weight parameters.

Maximum altitude neural network model 102 may be highly sensitive to training data 106. The quality of a maximum altitude 108 from neural network model 102 depends on the quality of training data 106. The disclosed embodiment uses the 4 parameters in the tables of starting altitude, cruise airspeed, temperature, and gross weight to execute the energy method to propagate the climb profile. Gross weight keeps decreasing as the aircraft executes the energy climb. These values may be validated using lookup tables or compared to maximum altitudes provided by the original equipment manufacturer.

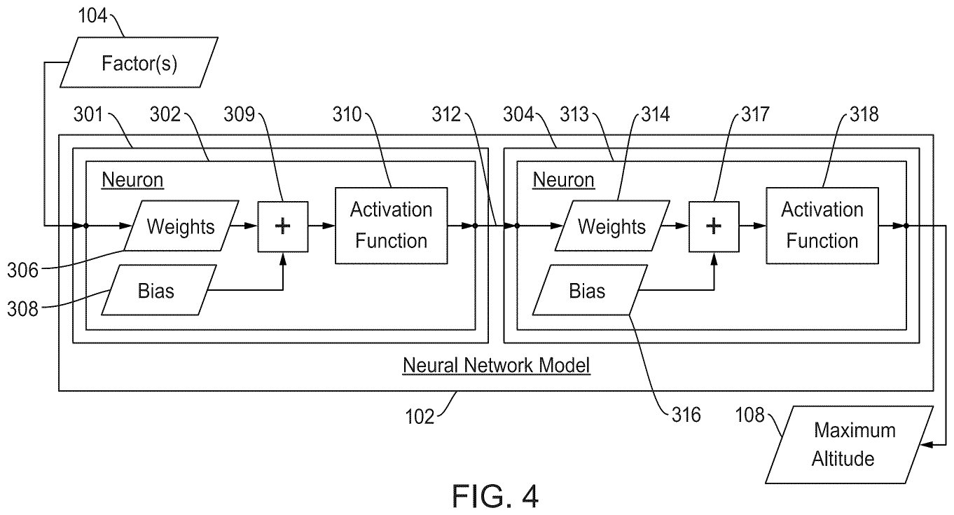

FIG. 4 depicts a block diagram of an example neural network topology for maximum altitude neural network model 102 according to the disclosed embodiments. Neural network model 102 may implement a number of hidden layers, a number of neurons in each layer, and a number of transfer functions. For example, neural network model 102 may be a single layer neural network model, a two-layer neural network model, and the like may be implemented. A single layer neural network model is disclosed for brevity.

Neural network model 102 includes a hidden layer 301 and an output layer 304. More than one hidden layer 302 may be implemented. Hidden layer 302 includes a plurality of neurons 302. A single neuron 302 is shown in FIG. 4 for brevity, but the topology of neuron 302 may be repeated for each neuron of hidden layer 301. In some embodiments, the number of neurons 302 is 8, 14, 16, and the like.

Each neuron 302 receives factors 104 to be used in determining a maximum altitude 108 for an aircraft. Factors 104 may be fed into neural network model 102. Preferably, factors 104 include 4 inputs, such as airspeed, aircraft weight, present altitude, and temperature. Weights 306 are applied to each factor 104 and summed using summation operation 309 with bias 308. Weights 306 may represent the attributes that neural network model 102 learns during training. In other words, weights 306 may be determined using training data 106. Each neuron 302 may include its own sets of weights connecting it to the neurons in the previous layer or to factors 104.

Bias 308 may be an additional attribute to shift the activation function that follows, to allow more flexibility in modeling the data. Bias 308 may be applied in each neuron 302. This feature enables neural network model 102 to fit the data better by adjusting the output along with the weighted sum of inputs.

After calculating the weight sum of inputs, or factors 104, and adding bias 308, the result of summation operation 309 is passed to activation function 310. Activation function 310 also may be known as a transfer function. Activation function 310 may provide non-linearity to neural network model 102. In some embodiments, activation function 310 may implement a tangent sigmoid, or TANSIG, function, or a rectified linear unit, or RELU, function. Activation function 310 outputs its result to the neurons in the next hidden layer or to output layer 304.

Output layer 304 may include a single neuron 313 that receives the outputs from neurons 302 of hidden layer 301. Neuron 313 applies weights 314 to the outputs and uses summation function 317 to sum the results with bias 316. The result is provided to activation function 318, which operates like activation function 310. The output of activation function 318 of output layer is a predicted maximum altitude 108. Thus, the disclosed embodiments may implement the processes disclosed above to train neural network model 102 to predict maximum altitudes for a variety of aircraft under many different conditions.

In some embodiments, neural network model 102 is a certifiable neural network. As maximum altitude is not a parameter to be missed without serious damage to aircraft and personnel, the neural network model should come with guarantees and assurances about its behavior under specific conditions. Such guarantees may involve formal verification or certification to ensure the neural network model operates within certain bounds or constraints. Thus, neural network model 102 may be simple enough to be certifiable using training data 106 and the disclosed processes.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A method for training a neural network model for determining a maximum altitude for an aircraft, the method comprising:
generating a table having at least one of a value for a parameter of a residual rate of climb (RROC) threshold and a value for a parameter of a maneuver margin threshold;
populating the table with values for a plurality of variable parameters, wherein the plurality of variable parameters includes at least one of an aircraft gross weight, a temperature, a cruise airspeed, and a present altitude;
propagating a climb profile using an energy method for a vertical integration step to determine an amount of fuel used in climbing to an updated present altitude in the table;
determining whether the values of parameters in the table fail to meet at least one of a plurality of criteria for the updated present altitude;
if the values of the parameters in the table fail to meet at least one of the plurality of the criteria, determining a maximum altitude associated with the values for the parameters; and
training the neural network model with the parameters in the table and the maximum altitude, wherein the neural network model is trained to determine a predicted maximum altitude for the aircraft.

2. The method of claim 1, wherein the plurality of criteria includes a structural altitude for the aircraft, the structural altitude being a constant value.

3. The method of claim 1, wherein the plurality of criteria includes a thrust limited altitude.

4. The method of claim 3, wherein the thrust limited altitude is compared to the value for the parameter of the RROC threshold in the table.

5. The method of claim 4, wherein the thrust limited altitude corresponds to a value for an instantaneous rate of climb of the aircraft based on the parameters in the table.

6. The method of claim 1, wherein the plurality of criteria includes a maneuver margin limited altitude.

7. The method of claim 6, wherein the maneuver margin limited altitude is compared to the value for the parameter of the maneuver margin threshold in the table.

8. The method of claim 7, wherein the maneuver margin limited altitude corresponds to a load factor of the aircraft.

9. The method of claim 1, further comprising determining whether the adjusted aircraft gross weight is below a no fuel weight of the aircraft.

10. The method of claim 9, further comprising determining the maximum altitude based on the parameters if the adjusted aircraft gross weight is below the no fuel weight of the aircraft.

11. The method of claim 1, wherein determining the maximum altitude includes identifying a value for the parameter of the present altitude for the table having the parameters for the RROC threshold and the maneuver margin threshold and previous values for the plurality of variable parameters of the table.

12. The method of claim 11, wherein identifying the present altitude includes determining the value for the present altitude prior to the vertical integration step.

13. The method of claim 12, wherein the previous values for the plurality of variable parameters include the values for the plurality of variable parameters corresponding to the value for the present altitude prior to the vertical integration step.

14. The method of claim 1, further comprising adjusting the aircraft gross weight in the table based on the amount of fuel used.

15. A method for training a neural network model for determining a maximum altitude for an aircraft, the method comprising:
generating aircraft performance tables, wherein each table includes a plurality of specified parameters and a plurality of variable parameters,
the plurality of specified parameters includes at least one of a residual rate of climb (RROC) threshold and a maneuver margin threshold, and
the plurality of variable parameters includes at least one of an aircraft gross weight, a temperature, a cruise airspeed, and a present altitude, wherein the plurality of variable parameters changes within the aircraft performance tables;
determining a maximum altitude for each table of the aircraft performance tables by
incrementing the present altitude according to a vertical integration step,
adjusting the aircraft gross weight using an energy method for a climb rate,
determining the maximum altitude for the table if the plurality of specified parameters and the plurality of variable parameters fail to meet one of a plurality of criteria; and
training the neural network model using the maximum altitudes for the aircraft performance tables having the plurality of specified parameters and the plurality of variable parameters, wherein the neural network model is configured to predict the maximum altitude for the aircraft.

16. The method of claim 15, wherein the plurality of criteria includes a structural altitude for the aircraft.

17. The method of claim 15, wherein the plurality of criteria includes a thrust limited altitude.

18. The method of claim 15, wherein the plurality of criteria includes a maneuver margin limited altitude.

19. A system having a neural network model to predict a maximum altitude for an aircraft, the system comprising:
the neural network model including
at least one hidden layer having a plurality of neurons configured to receive a plurality of factors associated with the aircraft; and
an output layer having a plurality of neurons to receive the output of the plurality of neurons of the at least one hidden layer and predict the maximum altitude for the aircraft,
wherein the at least one hidden layer and the output layer are trained by aircraft performance tables;
a processor and a memory,
wherein the memory includes instructions that, when executed on the processor, configures the processor to
generate the aircraft performance tables, wherein each table includes at a plurality of specified parameters and a plurality of variable parameters,
the plurality of specified parameters includes at least one of a residual rate of climb (RROC) threshold and a maneuver margin threshold, and
the plurality of variable parameters includes at least one of an aircraft gross weight, a temperature, a cruise airspeed, and a present altitude, wherein the plurality of variable parameters changes within the aircraft performance tables;
determine a maximum altitude for each table of the aircraft performance tables by the processor being configured to
increment the present altitude according to a vertical integration step,
adjust the aircraft gross weight using an energy method for a climb rate,
determine the maximum altitude for the table if the plurality of specified parameters and the plurality of variable parameters fail to meet one of a plurality of criteria; and
train the neural network model using the maximum altitudes for the aircraft performance tables having the plurality of specified parameters and the plurality of variable parameters, wherein the neural network model is configured to predict the maximum altitude for the aircraft.

20. The system of claim 19, wherein the plurality of criteria includes a structural altitude, a thrust limited altitude, and a maneuver margin limited altitude.
